(19) United States
(12) Patent Application Publication
(10) Pub. No.: US 2008/0131610 A1
(43) Pub. Date: Jun. 5, 2008

(54) Method for Coating a Workpiece

(75) Inventors: Manuel Hertter, Muenchen (DE); Andreas Jakimov, Muenchen (DE); Wolfgang Wachter, Muenchen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 11/792,805

(22) PCT Filed: Nov. 30, 2005
(86) PCT No.: PCT/DE05/02160

§ 371 Date: Jun. 11, 2007

(30) Foreign Application Priority Data
Dec. 10, 2004 (DE) 10 2004 059 549.6

(51) Int. Cl. B05D 1/08

(52) U.S. Cl. 427/447; 427/446

(57) ABSTRACT

A method for coating a workpiece, whereby a coating material and an aggregate material are applied to the workpiece by thermal spraying. In addition to the coating material, an aggregate material in which or to which a fluorescent marker material is firmly fixed is applied to the workpiece. The spraying process is monitored online by detecting and evaluating at least the particles of the fluorescent marker material present in the spray jet.

The present invention relates to a method for coating a workpiece according to the definition of the species set forth in claim 1.

Numerous methods for coating workpieces are known from the related art. In the case of so-called thermal spraying, it is a question of coating processes in which a thermally active coating material is spray-coated or spray-discharged onto a surface of a workpiece to be coated. Since virtually all meltable coating materials are suited for use, coatings having different properties or functions, such as thermal insulation, corrosion protection or antiabrasion protection, can be realized using thermal spraying processes. In thermal spraying processes, virtually limitless combinations of the material of the object or workpiece to be coated and of the thermally active coating material to be used for the coating, are possible.

Depending on the heat source used, one differentiates among various thermal spray-coating processes, namely among plasma spraying, arc spraying, flame spraying or also high-speed flame spraying, for example. Cold-kinetic compaction is also a thermal spray-coating process. The selection of the appropriate thermal spray-coating process depends, for example, on the coating material, the desired coating properties, and on the costs entailed in the particular case.

To produce a porous coating on the workpiece to be coated, for example, it is already known, in addition to the actual coating material, to deposit an aggregate material by thermal spray-coating of the same onto the workpiece to be coated, following the thermal spray-coating process, the aggregate material being decomposed or disintegrated, in order to thereby produce the porous coating. Thus, the decomposing aggregate material leaves behind pores in the coating. In this context, the aggregate material decomposes, in particular, in response to a thermal treatment of the coated workpiece. In the case that porosity is not desired, the aggregate material—to the extent that it does not have a detrimental effect—can also remain in the coating and influence the properties thereof.

When it comes to coating workpieces using a thermal spray-coating process, quality control plays a critical role in the formation of the coating. Only when the coating meets specified quality criteria can the coated workpiece pass the quality control and, if indicated, undergo further processing. Since the aggregates which are deposited, together with the coating material, onto the workpiece in order to produce a porous coating, for example, are not identifiable or detectable using an on-line quality control process, the related art provides for using destructive random-sampling testing methods for quality control purposes. On the one hand, a quality control process that is destructive to the workpiece is costly and time-consuming; on the other hand, only random-sampling controls can be carried out.

Against this background, it is an object of the present invention to devise a novel method for coating a workpiece.

This objective is achieved by a method for coating a workpiece as set forth in claim 1. In accordance with the present invention, in addition to the coating material, an aggregate material, in or to which a fluorescent marker material is permanently bound, is deposited onto the workpiece, the spray-coating process being monitored on-line in that at least the particles of the fluorescent marker material contained in a spray jet are identified and analyzed.

Along the lines of the method of the present invention, an aggregate material in or to which a fluorescent marker material is bound, is used for coating a workpiece. The fluorescent marker material is identified on-line during the spray-coating process. Thus, when producing porous coatings, for example, inferences may be made already during the spray-coating process with regard to the quality of the porous coating that is being formed subsequently to the decomposition of the aggregate material. This makes it possible, for the first time, to subject coatings manufactured using thermal spray-coating processes to a comprehensive on-line quality control, thereby eliminating the need for destructive testing methods.

When producing porous coatings, the aggregate material, together with the fluorescent marker material, is decomposed subsequently to the spray-coating process, in particular in response to thermal treatment of the coated workpiece.

Preferred embodiments of the present invention are derived from the dependent claims and from the following description. An exemplary embodiment of the present invention is clarified in greater detail in the following with reference to the drawing, without being limited thereto.

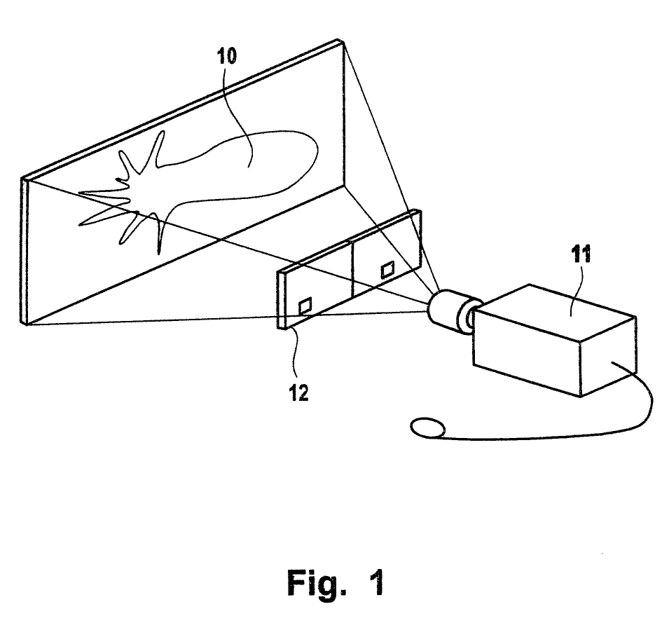

FIG. 1 shows a highly schematized representation of a device for coating a workpiece, to illustrate the method according to the present invention.

The present invention is described in greater detail in the following with reference to FIG. 1, using the manufacture of a porous coating as an example.

The present invention relates to a method for coating a workpiece using thermal spray-coating processes. To this end, a coating material, together with an aggregate material, is deposited by thermal spraying, namely spray-coated or spray-discharged onto the workpiece. Subsequently to the thermal spray-coating process, the aggregate material is decomposed, in particular, by a thermal treatment of the coated workpiece, in order to thereby produce a porous coating on the workpiece.

The present invention is described in the following in the context of plasma spraying as a preferred thermal spray-coating process. However, it is not intended that the present invention be limited to plasma spraying. Rather, the present invention may also be used in connection with other thermal spray-coating processes, such as flame spraying, high-speed flame spraying, wire-arc spraying or cold-kinetic compaction, for example.

Plasma spraying, as such, is sufficiently known from the related art. Thus, for example, the European Patent EP 0 851 720 B1 describes a plasmatron suited for use in plasma spraying processes. To complete the description, it should merely be noted that, during plasma spraying processes, an electric arc is ignited between a cathode and an anode of a plasmatron (not shown). This electric arc heats a plasma gas flowing through the plasmatron. As plasma gases, argon, hydrogen, nitrogen, helium or mixtures of these gases are used. In response to heating of the plasma gas, a plasma jet is formed which, at the core, can reach temperatures of up to 20,000° C. The coating material used for the coating process is injected into the plasma jet with the aid of a carrier gas. In addition, this coating material to be used for the coating process is accelerated by the plasma jet to a high velocity. The material accelerated in this manner is deposited, namely sprayed onto the workpiece to be coated.

To produce the porous coating, in addition to the coating material, an aggregate material is also sprayed onto the workpiece to be coated. In this connection, a spray jet is formed, on the one hand, the spray jet being formed by the plasma jet and, on the other hand, by the particle jet of the coating material and of the aggregate material. The particles impinge with a high thermal, as well as kinetic energy onto a surface of the workpiece to be coated and form a coating there. The desired coating properties are obtained as a function of the parameters of the spray-coating process.

Along the lines of the present invention, an aggregate material in or to which a fluorescent marker material is permanently bound, is used during the thermal spraying process. During the thermal spraying process, both the particles of the coating material, as well as the particles of the marker material, which is permanently bound in or to the aggregate material, are excited to luminesce, making it possible for the particles of the coating material contained in the spray jet or particle jet, and the particles of the marker material to be identified and analyzed using an on-line monitoring process. The fluorescent marker material, as well as the coating material, may be excited, for example, by the plasma jet. Alternatively, the excitation may be effected by a laser source which excites the particles into luminescence.

In this connection, it should be pointed out that marker materials are used which luminesce in a different wavelength region than the coating material. This makes it possible to make the distinction in the particle jet between the particles of the coating material and the particles of the marker material, and thus of the aggregate material. As marker materials, laser dyes are used in particular, whose fluorescence is within the visible wavelength region. Particularly suited as a laser dye is Rhodamine 6G, whose fluorescence emission maximum is approximately 560 nm. Rhodamine 6G may be permanently bound in organic aggregates, such as polyester, in that it is diffused into polyester, for example.

The monitoring and analysis of the spray-coating process are carried out, as previously mentioned, using on-line process control or regulating systems. The monitoring and analysis of the spray-coating process are clarified in the following with reference to FIG. 1. In a highly schematized view, FIG. 1 shows a spray jet 10 that forms during the plasma spraying process. A camera 11 optically monitors spray jet 10 through an optical filter 12. In the illustrated exemplary embodiment, camera 11 is designed as a CCD camera. The optical filter may be designed as a neutral filter, color filter or bandpass filter. A plurality of cameras and/or other process control systems, in particular a spectrometer, may also be used for monitoring the spray-coating process.

The image captured or acquired by camera 11 is delivered to an image-processing system (not shown in detail). Properties of the optically monitored spray jet are ascertained in the image-processing system from the data acquired by camera 11. The properties of spray jet 10 ascertained from the optical monitoring thereof are compared to predefined nominal values for these properties. If a deviation in the ascertained properties (actual values) of the spray jet from the predefined values (nominal values) for the properties is recognized, then the process parameters for the plasma spraying process are automatically adapted by a controller.

The method described here may, of course, also be used in combination with other methods for monitoring the spray jet, such as, in particular, the laser-induced fluorescence method.

Finally, it is noted that the present invention is, in fact, preferably used in the manufacturing of porous coatings, but is not limited to this type of application. Rather, the present invention may also be used for manufacturing solid coatings, in such a case, the aggregate material remaining, together with the fluorescent marker material, in the coating. Thus, for example, boron nitride (BN) or bentonite may be introduced as an aggregate into a solid coating, in order to form a predetermined breaking point in the coating. The boron nitride in the coating is identifiable on-line by a fluorescent marker material that is bound to or in the boron nitride.

1-6. (canceled)

7: A method for coating a workpiece, a coating material and an aggregate material being deposited by a thermal spray-coating process onto the workpiece, comprising:
permanently binding in or to the aggregate material a fluorescent marker material; and
monitoring the spray-coating process on-line, the monitoring including analyzing and identifying the fluorescent marker material contained in the spray jet.

8: The method as recited in claim 7 further comprising, subsequently to the spray-coating process, decomposing the aggregate material in order to produce a porous coating.

9: The method as recited in claim 8 wherein the decomposing is in response to thermal treatment of the coated workpiece.

10: The method as recited in claim 7 further comprising, subsequently to the spray-coating process, decomposing the aggregate material together with the fluorescent marker material is decomposed in order to produce a porous coating.

11: The method as recited in claim 10 wherein the decomposing is in response to thermal treatment of the coated workpiece.

12: The method as recited in claim 7 wherein the aggregate material is an organic aggregate material.

13: The method as recited in claim 12 wherein the aggregate material is polyester.

14: The method as recited in claim 7 wherein the fluorescent marker material is a laser dye.

15: The method as recited in claim 14 wherein the laser dye is Rhodamine 6G.

16: The method as recited in claim 7 wherein, during the spray-coating process, the fluorescent marker material is excited to luminesce and the monitoring includes capturing the luminescence by a camera.
